(19) United States
(12) Patent Application Publication
(10) Pub. No.: US 2021/0000243 A1
(43) Pub. Date: Jan. 7, 2021

(54) Personal care product recommendation platform

(71) Applicant: Gemma Labs Inc., Seattle, WA (US)

(72) Inventors: Allison Oaks Harr, Seattle, WA (US); Adam Dean Loving, Seattle, WA (US); Cynthia L. Moser, Seattle, WA (US); Richard Benjamin Rush, Seattle, WA (US)

(73) Assignee: Gemma Labs Inc., Seattle, WA (US)

(21) Appl. No.: 16/460,922

(22) Filed: Jul. 2, 2019

(51) Int. Cl. A45D 44/00; G06Q 10/08; G06F 9/54

(52) U.S. Cl. CPC A45D 44/005; A45D 2044/007; G06F 9/542; G06Q 10/087

(57) ABSTRACT

Disclosed is a personal care product platform that implements a personal care product assessment process. The process is configured to analyze data regarding several factors that impact characteristics of an individual, such as the individual's hair. Based on that analysis, a selection of personal care products is provided to the individual that may be combined in defined ways to achieve the desired results for that individual's particular characteristics, desires, and preferences. The analysis determines both what personal care products to combine to satisfy the individual's current needs, as well as predicts what changes, if any, should be made to the personal care products to continue to satisfy the individual's needs as those needs change over time.

### SUMMARY OF THE DISCLOSURE WITH BACKGROUND INFORMATION

Retail sales is a highly competitive industry, especially so in the health and beauty segment. Profit margins can be small so manufacturers and retailers must often make decisions and sacrifices to improve sales performance. In one example, retailers may use shelf location for products as a tool to maximize space profitability. Various products compete not only for consumer attention, but also for shelf space in retail stores. The need for more shelf space to display multiple products works against any particular vendor.

Personal care products, especially hair care products, are usually designed, developed, and prepared to include a fixed set of ingredients prior to packaging and being sold to the consumer. However, personal care products can be highly specific to an individual based on traits such as physiology, personal preferences, environmental factors, and the like. Accordingly, personal care product manufacturers are constantly seeking a balance between offering a sufficient number of alternative formulations to address individual needs and wants with the problem of trying to supply an inordinate number of unique product formulations. The more product formulations, the greater the cost of production and the more difficult it can be to secure shelf space.

For those and other reasons, consumers are typically forced to select their personal care products from fewer than an ideal number of alternatives. Consumers are unable to acquire products that are customized for their specific hair type, hair problems, and personal preferences. Compounding this problem is the fact that an individual's hair needs and problems frequently change with environmental influences, such as the weather, the season, changes made to the individual's hair or haircare routine, and the individual's age and health. Consumers must either frequently reassess their hair care regime and hope for the best when choosing from a limited number of pre-formulated offerings, or accept results that can be below their hopes and expectations.

The present disclosure describes a personal care product platform that enables consumers to maintain a base level performance specifically tailored to the physical and chemical attributes of their hair. In addition, the platform enables customization of those products to address their unique and changing hair needs. In a preferred aspect, the platform alters or adjusts that customization at a specified frequency, or in response to other events, or both.

Generally stated, the personal care product platform implements a hair and environment assessment process to analyze data regarding several factors that impact an individual's hair. Examples of such factors include the individual's physiological traits (e.g., age, gender, race, etc.), hair type (e.g., physical and chemical characteristics), hair problems or desires, and projected hair needs that may arise in a given timeframe. The projected hair needs may be based on a prediction of impact on the hair by environmental, chemical, or consumer effected changes. Data for those factors may come either from the individuals themselves or from external sources, such as weather forecasting services. The process may also predict physiological changes (e.g., age, hormones, health, etc.) that may impact an individual consumer in a specified timeframe (such as weeks or months). The changes are analyzed to determine what impact they may have on the individual's hair, such as the quality, appearance, or feel the hair.

The output of the process is a selection of products (e.g., shampoo, conditioner and/or additional performance additive) that delivers superior benefits to the individual in the subject timeframe. The selection of products is provided to the individual so that the individual can combine them in a specified manner prior to or during use to achieve the intended results. Alternatively, the selection of products may be combined and then provided to the individual for use during the subject timeframe.

### BRIEF DESCRIPTION OF THE DRAWINGS

FIG. 1 is a conceptual block diagram generally illustrating components of a personal care product delivery platform, in accordance with this disclosure.

FIG. 2 is a conceptual block diagram of a user profile which may be used in embodiments of the disclosure.

FIG. 3 is a conceptual block diagram of an inventory of personal care products which may be used in embodiments of the disclosure.

FIG. 4 is a conceptual block diagram of prediction engine for determining a proposed combination of personal care products in accordance with the disclosure.

FIG. 5 is a functional flow diagram generally illustrating a hair and environment assessment algorithm in accordance with embodiments of the disclosure.

FIG. 6 is a functional flow diagram illustrating an embodiment of a personal care product recommendation process in accordance with the disclosure.

FIG. 7 is a conceptual block diagram generally illustrating a hardware computing device that may be used to implement embodiments of the disclosure.

### DETAILED DESCRIPTION OF EMBODIMENTS

Briefly described, embodiments of the disclosure are directed to a personal care product platform that implements a hair and environment assessment process. The process is configured to analyze data regarding several factors that impact an individual's hair. Based on that analysis, a selection of personal care products are provided to the individual that may be combined in defined ways to achieve the desired results for that individual's hair. The analysis determines both what personal care products to combine to satisfy the individual's current needs, as well as predicts what changes, if any, should be made to the personal care products to continue to satisfy the individual's needs as those needs change over time.

Embodiments of the disclosure will be explained herein with reference to conceptual block diagrams and functional flow diagrams. The conceptual block diagrams generally describe functional components that may be implemented in computer hardware, software, or firmware as special purpose computing devices which perform the functions described. The functional flow diagrams generally describe processes that may be performed to accomplish the tasks described. These embodiments are illustrative only and do not limit the scope or breadth of the teachings of this disclosure.

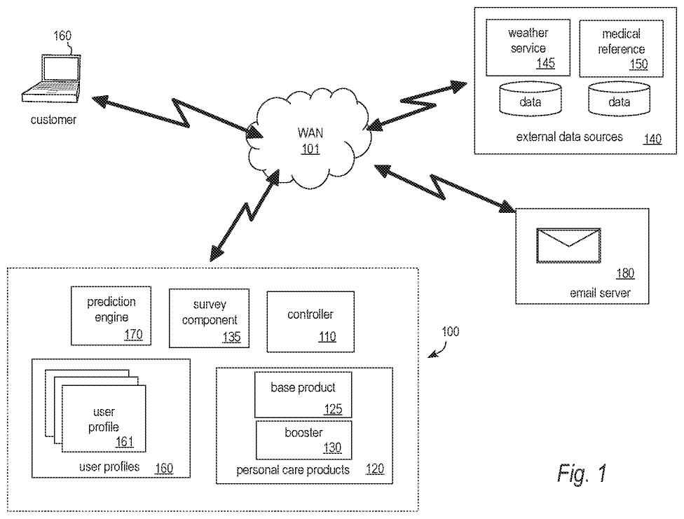

FIG. 1 is a conceptual block diagram generally illustrating components of a personal care product delivery platform (“the platform”) 100, in accordance with this disclosure. The platform may be implemented as one or more computing devices which are specially programmed to operate as a special purpose machine. The platform may additionally interact with various other computing devices which provide supplemental or complementary services.

The platform includes a controller 110, which is a component specially configured to govern interactions between the platform's several other components. The controller may provide administrative and configuration functions for the platform. In addition, the controller may facilitate communications between various components of the platform and other computing devices, such as web services hosted by disparate content publishers, or the like.

The platform further includes an inventory of personal care products 120, such as hair care products. Although described herein as hair care products, it will be appreciated that many other types of personal care products may equally benefit from the teachings of this disclosure. Examples of other types of personal care products include creams, lotions, gels, sprays, cleansers, coloring agents, and the like. In one embodiment, the inventory of personal care products includes at least one “base” product 125 and at least one “booster” product 130. The base product is one of a relatively small selection of core products that is selected as being a coarse match to a formulation that would be ideal for an individual. In one example, the base product may be a shampoo or a conditioner. The inventory of personal care products 120 may include a small number of discreet base products, such as three or four base shampoos and three or four base conditioners.

The inventory of personal care products further includes a more extensive number of performance enhancers (“boosters”) 130 which may be incorporated into the base products as an additive agent to modify, enhance, decrease, or otherwise alter the characteristics of the base products to enhance its properties in certain areas. For example, a booster 130 may provide surface modifications to mitigate the transpiration of moisture in and out of the hair fiber. Alternatively, the boosters may also provide new properties to a base product, such as a texture, scent or color that would otherwise be absent from the base product.

A survey component 135 is configured to prompt an individual for information that may be used to compile an estimate of which base product is a closest match for the hair needs of the individual. In addition, the survey component may prompt the individual for information that may be used to identify one or more boosters that can be added to the base product to enhance the performance of the combined product. The survey component may be implemented as a user interface component on a website, for example. Alternatively, the survey component may be implemented as a mobile application. In yet another alternative, the survey component may be implemented as some combination of services used to prompt or extract information from an individual.

The platform 100 may interact with one or more external data sources 140 which provide information that may be used to create a unique formulation. For instance, a weather service 145 may provide weather information for various locations. In another example, a medical reference service 150 may provide information about the impact of certain pharmaceuticals on the hair. Many other examples will be apparent to those skilled in the art.

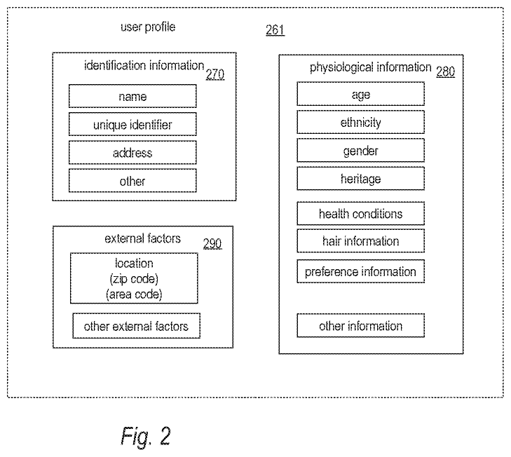

The platform maintains one or more user profiles 160 for each individual customer. One sample user profile 161 is illustrated in FIG. 2 and described below. Generally stated, the user profile stores information about an associated customer, such as physiological information about the customer, preferences and subjective desires of the customer, and environmental information that helps determine the customer's hair needs. The survey component may store the information received from the individual in a particular user profile for that individual.

A prediction engine 170 is used by the platform to predict changes that may occur to the hair needs of a particular individual based on information in the user profile for that individual. For example, the prediction engine may use zip code information stored in the user profile for an individual to retrieve a weather forecast for that zip code for the ensuing days and weeks. The weather forecast may reveal that the humidity level will be higher than normal soon, which may tend to make the individual's hair more frizzy than usual. The prediction engine 170 may use that information to modify the particular booster or boosters during that time period.

An email server 180 may be used by the platform to communicate with its customers (the individuals) for the purpose of delivering recommendations for combinations of base products and boosters. In one particular embodiment, the platform may periodically, routinely, or even constantly review the individual's user profile 161 and external data 140 for the purpose of refining the recommended combination of boosters for the base products. The platform may transmit notices or updates to individuals to inform them that there has been a change to the individual's recommended personal care product selections. Conversely, the email server 180 may receive and process incoming messages from individuals with updated information, such as feedback on the performance of the individual's recommended combination of base products and boosters.

Various computing devices, including components of the platform, communicate with each other over a wide area network, such as the Internet 101. The wide area network may also facilitate access between the platform and mobile devices. These and other examples will be apparent to those skilled in the art.

FIG. 2 is a conceptual block diagram of a user profile 261 which may be used in embodiments of the disclosure. As introduced above, the user profile includes information that describes characteristics of an individual for use in determining an appropriate combination of personal care products. The information is stored in particular data fields within the user profile for various characteristics of the individual. Examples of the type of information that may be stored within the user profile include identification information 270, such as the individual's name 271 and an anonymous identifier 272 for the individual. The individual's address information 273 may also be stored, as well as other identification information 274.

In addition to identification information 270, physiological information 280 about the individual may be stored. The types of physiological information that may be stored are limitless, but include information about the individual such as the individual's age, ethnicity, gender, heritage, health conditions, hair type, hair condition, hair treatment history, hair care and styling routine, style preferences, product usage experience feedback and the like.

In addition to identification and physiological information, data may be stored to identify external factors 290 that may influence the individual's hair. Examples of such data include a zip code or area code for the individual so that influences like indoor and external air temperatures and quality, including temperatures, humidity, pollution and UV levels may be identified and included in the recommendation process.

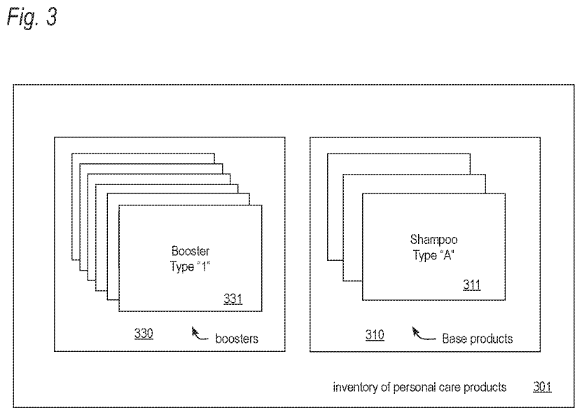

FIG. 3 is a conceptual block diagram of an inventory 301 of personal care products which may be used in embodiments of the disclosure. As introduced above, the inventory 301 includes base products 310 and boosters 330. In the preferred embodiment, the base products include shampoos and leave-on or rinse-out conditioners, and the boosters include additives that enhance or augment the performance of the base products. In addition, in some cases, the boosters alter the actual chemical formulations of the base products. In other cases, the boosters may simply add features, such as a scent or color, to the base product.

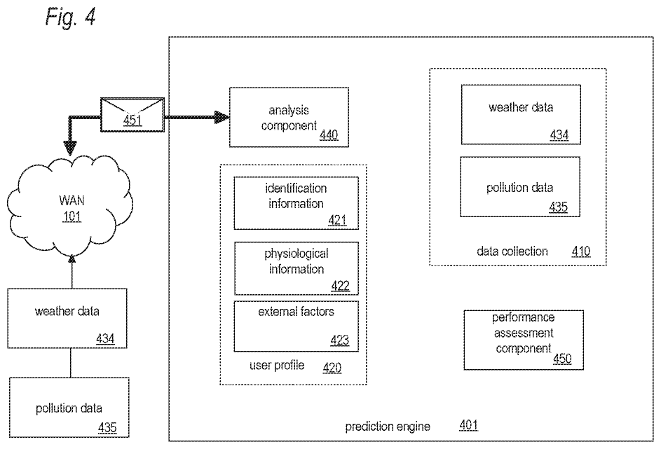

FIG. 4 is a conceptual block diagram of a prediction engine 401 for determining a proposed combination of personal care products in accordance with the disclosure. In certain embodiments, a data collection component 410 retrieves information about an individual, about the individual's hair, and about external factors that may influence the individual's hair. The data collection component may retrieve that information from a user profile 420 associated with the individual. Their hair type and hair problems may be self-assessed or assessed by a trained hair professional such as a stylist, medical clinician or scientist.

In addition, the data collection component 410 may retrieve external data, such as weather data 434 or pollution data 435, based on information from the user profile 420. For example, the prediction engine may use geographic data provided by the individual to determine real-time and forecasted environmental factors (e.g., temperature, humidity, pollution, UV exposure levels, etc).

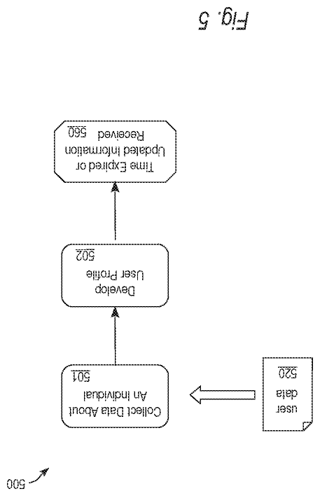

An analysis component 440 is implemented to execute a hair and environment assessment process to determine a proper combination of base product and boosters to achieve the individual's goals. One illustrative instance of a hair and environment assessment process is illustrated in FIG. 5 and described below. Briefly described, the analysis component uses the various data provided by the individual and the external data to identify the most appropriate combination of base products and boosters. It should be appreciated that the analysis component may be constantly updating recommendations for the individual based on actual or predicted changes that may affect the individual's hair.

The prediction engine 401 may also include a performance assessment component 450 that may be used to influence recommendations based on, for example, feedback 451 from the individual about how well prior recommendations have performed. That feedback may come in the form of survey data returned by the individual. Alternatively, the individual may submit a photograph of the individual's hair for image analysis. The prediction engine may employ Machine Learning (ML) techniques to identify the individual's hair type from the photograph.

In another alternative, the individual may submit a hair sample for analysis so that the performance of prior recommendations may be more scientifically assessed. For instance, the prediction engine 401 may employ DNA testing to determine the individual's hair type from a strand of hair. In still other embodiments, formulizers may assess feedback data using statistical methods to determine what changes to make to the shampoo, conditioner, and booster formulas to achieve the desired results for the individual's hair.

FIG. 5 is a functional flow diagram generally illustrating a hair and environment assessment process 500 in accordance with embodiments of the disclosure. The process begins at a data collection step 501 where an individual is prompted for information 520 to help assess the individual's hair type and needs. In one example, the individual may be prompted with a survey of personal information (e.g., gender, age, physiology, ethnicity, sex, race, and the like). In addition, the individual may be prompted to provide preferential information that is not physiological (e.g., preferred hair length or style, hair care regimen, desire for coloring, and the like). Even more information may be collected such as environmental information (e.g., zip code or area code, address, and the like).

A user profile is developed 502 using the information collected at the data collection step and stored for later reference. The user profile may include the collected information 520, as well as any follow up information obtained from other means, such as through feedback mechanisms. For example, a QR code (or text and numeric, or other graphic identifier) affixed directly to the products could be used to give the individual an immediate feedback mechanism via their mobile phone. The individual could point their phone at the code, and be taken to a Web site or app, where they could rate their satisfaction with the product. Detailed data like “did the formula suit your thick hair?” could also be collected.

The process 500 may also be repeated to update the user profile. For example, at the expiration of some predetermined time (e.g., monthly or quarterly) or in response to some other triggering event (e.g., delivery of a new batch of products or the occurrence of some life event for the individual) (step 560), the process 500 may be repeated to refresh, update, or supplement the user profile.

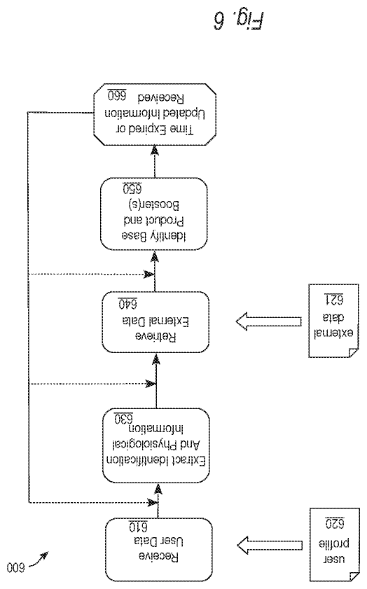

Once the data has been collected, the hair and environment assessment process 500 continues to a personal care product recommendation process, illustrated in FIG. 6 and described below.

FIG. 6 is a functional flow diagram illustrating an embodiment of a personal care product recommendation process 600 in accordance with the disclosure. The recommendation process is executed to compile a combination of a base product (e.g., a shampoo or conditioner) and one or more boosters (e.g., performance enhancing additive or scent) that are customized for each particular individual. In one preferred embodiment, a user profile 620 having information that describes physical traits of an individual's hair and information identifying external factors is received by a prediction engine (610) and analyzed for identification information and physiological information (630).

The identification information and physiological information are used to identify external factors that may impact the individual's hair, and external data is retrieved (640) corresponding to those external factors. Examples of such external factors include the weather at the location identified in the identification information or pollution data at the location. Other examples will also become apparent.

The identification information, physiological information, and external data are used to predict (650) a particular combination of base product and booster(s). That particular combination would then be delivered to the individual for use on that individual's hair for a period.

The recommended products could be delivered in packaging or formulations such that the base product (e.g., shampoo, conditioner) and booster are delivered in a single bottle or container. For example, a dosing cap may be used that houses the booster which may be deployed into the base product at the time of use.

At the conclusion of some predetermined or configured time period (e.g., monthly or quarterly) or in response to some other triggering event (e.g., updated information from a customer) (step 660), the process 600 may return and repeat any one of steps 630, 640, and/or 650 to reassess the needs and desires of the individual to ensure that the currently recommended base product and booster combination satisfies those needs and desires, and to adjust either or both in accordance with new needs or preferences.

In one enhancement, the recommendation process may employ a predictive ordering algorithm such that customers' delivery times are adjusted based on their rate of consumption of the product. In another enhancement, the recommendation process recomputes the recommended products routinely or periodically.

In still another enhancement, a “Dash” or usage status button could be included with the customer's initial shipment. The button would be configured by the customer to use their network access point (e.g., WiFi). The customer would then press the button to report their daily/weekly usage of the shampoo, and indicate when shampoo should be re-ordered.

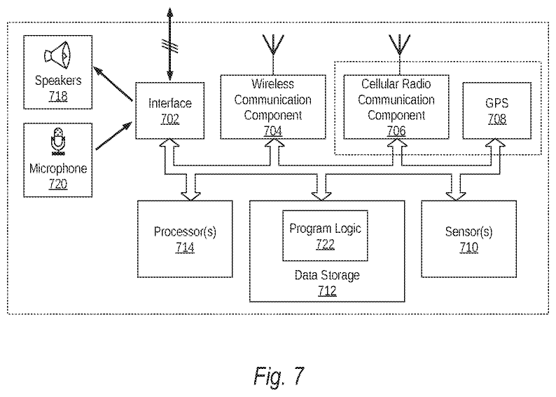

FIG. 7 is a conceptual block diagram generally illustrating a hardware computing device that may be used to implement embodiments of the disclosure. The computing devices in which embodiments are implemented may take one or more of several different configurations. For instance, physical computing hardware may be used as well as virtual computing environments. In addition, both fixed location and mobile devices may be used. Any combination of computing devices may be used to implement embodiments. However, once implemented, the embodiments of this disclosure transform the host computing device into a special purpose machine specially configured to accomplish the goals of this disclosure.

By way of example, FIG. 7 illustrates an example computing device 700. In some examples, components illustrated in FIG. 7 may be distributed across multiple computing devices. However, for the sake of example, the components are shown and described as part of one example computing device 700. The computing device 700 may be or include a mobile device (such as a mobile phone), desktop computer, laptop computer, email/messaging device, tablet computer, or similar device that may be configured to perform the functions described herein. Generally, the computing device 700 may be any type of computing device or transmitter that is configured to transmit data or receive data in accordance with methods and functions described herein.

The computing device 700 may include an interface 702, a wireless communication component 704, a cellular radio communication component 706, a global positioning system (GPS) receiver 708, sensor(s) 710, data storage 712, and processor(s) 714. Components illustrated in FIG. 7 may be linked together by a communication link 716. The computing device 700 may also include hardware to enable communication within the computing device 700 and between the computing device 700 and other computing devices (not shown), such as a server entity. The hardware may include transmitters, receivers, and antennas, for example.

The interface 702 may be configured to allow the computing device 700 to communicate with other computing devices (not shown), such as a server. Thus, the interface 702 may be configured to receive input data from one or more computing devices, and may also be configured to send output data to the one or more computing devices. The interface 702 may be configured to function according to a wired or wireless communication protocol. In some examples, the interface 702 may include buttons, a keyboard, a touchscreen, speaker(s) 718, microphone(s) 720, and/or any other elements for receiving inputs, as well as one or more displays, and/or any other elements for communicating outputs.

The wireless communication component 704 may be a communication interface that is configured to facilitate wireless data communication for the computing device 700 according to one or more wireless communication standards. For example, the wireless communication component 704 may include a Wi-Fi communication component that is configured to facilitate wireless data communication according to one or more IEEE 802.11 standards. As another example, the wireless communication component 704 may include a Bluetooth communication component that is configured to facilitate wireless data communication according to one or more Bluetooth standards. Other examples are also possible.

The cellular radio communication component 706 may be a communication interface that is configured to facilitate wireless communication (voice and/or data) with a cellular wireless base station to provide mobile connectivity to a network. The cellular radio communication component 706 may be configured to connect to a base station of a cell in which the computing device 700 is located, for example.

The GPS receiver 708 may be configured to estimate a location of the computing device 700 by precisely timing signals sent by GPS satellites.

The sensor(s) 710 may include one or more sensors, or may represent one or more sensors included within the computing device 700. Example sensors include an accelerometer, gyroscope, pedometer, light sensor, microphone, camera(s), infrared flash, barometer, magnetometer, Wi-Fi, near field communication (NFC), Bluetooth, projector, depth sensor, temperature sensor, or other location and/or context-aware sensors.

The data storage 712 may store program logic 722 that can be accessed and executed by the processor(s) 714. The data storage 712 may also store data collected by the sensor(s) 710, or data collected by any of the wireless communication component 704, the cellular radio communication component 706, and the GPS receiver 708.

The processor(s) 714 may be configured to receive data collected by any of sensor(s) 710 and perform any number of functions based on the data. As an example, the processor(s) 714 may be configured to determine one or more geographical location estimates of the computing device 700 using one or more location-determination components, such as the wireless communication component 704, the cellular radio communication component 706, or the GPS receiver 708. The processor(s) 714 may use a location-determination algorithm to determine a location of the computing device 700 based on a presence and/or location of one or more known wireless access points within a wireless range of the computing device 700. In one example, the wireless location component 704 may determine the identity of one or more wireless access points (e.g., a MAC address) and measure an intensity of signals received (e.g., received signal strength indication) from each of the one or more wireless access points. The received signal strength indication (RSSI) from each unique wireless access point may be used to determine a distance from each wireless access point. The distances may then be compared to a database that stores information regarding where each unique wireless access point is located. Based on the distance from each wireless access point, and the known location of each of the wireless access points, a location estimate of the computing device 700 may be determined.

In another instance, the processor(s) 714 may use a location-determination algorithm to determine a location of the computing device 700 based on nearby cellular base stations. For example, the cellular radio communication component 706 may be configured to identify a cell from which the computing device 700 is receiving, or last received, signal from a cellular network. The cellular radio communication component 706 may also be configured to measure a round trip time (RTT) to a base station providing the signal, and combine this information with the identified cell to determine a location estimate. In another example, the cellular communication component 706 may be configured to use observed time difference of arrival (OTDOA) from three or more base stations to estimate the location of the computing device 700.

In some implementations, the computing device 700 may include a device platform (not shown), which may be configured as a multi-layered Linux platform. The device platform may include different applications and an application framework, as well as various kernels, libraries, and runtime entities. In other examples, other formats or operating systems may operate the computing g device 700 as well.

The communication link 716 is illustrated as a wired connection; however, wireless connections may also be used. For example, the communication link 716 may be a wired serial bus such as a universal serial bus or a parallel bus, or a wireless connection using, e.g., short-range wireless radio technology, or communication protocols described in IEEE 802.11 (including any IEEE 802.11 revisions), among other possibilities.

The computing device 700 may include more or fewer components. Further, example methods described herein may be performed individually by components of the computing device 700, or in combination by one or all of the components of the computing device 700.

Many other uses and alternatives of the disclosure will become apparent from the foregoing teachings. In this detailed description, numerous examples have been set forth to provide a thorough understanding of the described embodiments. On the other hand, some well-known features have not been described in detail in order to not obscure the description.

A person skilled in the art in view of this description, taken as a whole, will be able to implement various preferred embodiments. However, the specific preferred embodiments disclosed and illustrated herein are not to be considered in a limiting sense. Indeed, it should be readily apparent to those skilled in the art that what is described herein may be modified in numerous ways. Such ways can include equivalents to what is described herein. In addition, embodiments may be practiced in combination with other systems. The following claims define certain combinations and subcombinations of elements, features, steps, and/or functions, which are regarded as novel and non-obvious. Additional claims for other combinations and subcombinations may be presented in this or a related document.

What is claimed is:

1. A system for recommending personal care products, comprising:
a user profile in which is stored identification information and physiological information, the identification information identifying an individual, the physiological information describing physiological characteristics about a personal aspect of the individual, the user profile further including information identifying external factors that tend to impact at least one of the physiological characteristics of the individual, at least one of the external factors changing with time;
a data collection component configured to retrieve external data associated with at least one external factor, the external data being accessible from a data repository accessible over a computing network;
a prediction component configured to analyze the physiological information and the external data to identify a selected base product from an inventory of personal care products, the selected base product being chosen as a most likely compatible with the characteristics of the individual as influenced by the external factors, the prediction component being further configured to identify a selected booster from the inventory of personal care products, the selected booster being chosen to augment the selected base product, when combined with the selected base product, to further conform the base product to the characteristics of the individual; and
a delivery component configured to deliver to the individual the selected base product and the selected booster, the delivery component being further configured to deliver additional base products and selected boosters.

2. The system recited in claim 1, wherein the inventory of personal care products comprises hair care products.

3. The system recited in claim 2, wherein the hair care products comprise at least one of shampoo or hair conditioner.

4. The system recited in claim 1, wherein the delivery component is further configured to deliver the additional base products and selected boosters in accordance with a schedule described in the user profile.

5. The system recited in claim 1, wherein the delivery component is further configured to deliver the additional base products and selected boosters in response to a triggering event.

6. The system recited in claim 5, wherein the triggering event is one or more of receiving an update to the user profile, receiving a request for additional product, or detecting a change in external factors that suggests a different selected base product or selected booster.

7. The system recited in claim 1, wherein the delivery component is configured to prompt the data collection component to refresh the external data, and the delivery component is further configured to prompt the prediction component to repeat the analysis of the physiological information and the refreshed external data to identify a new selected base product and a new selected booster.

8. The system recited in claim 7, wherein one or both of the new selected base product and the new selected booster are the same as the original selected base product and the original selected booster.

9. The system recited in claim 1, wherein the external factors comprise at least one of weather data for a location identified in the user profile or pollution data for the location identified in the user profile.
